(19) United States
(12) Patent Application Publication
(10) Pub. No.: US 2017/0352019 A1
(43) Pub. Date: Dec. 7, 2017

(54) METHOD AND SYSTEM FOR EFFICIENT SHARED TRANSACTION PROCESSING

(71) Applicants: Xi Li, Singapore (SG); Weilong Liu, Singapore (SG); Mo Yang, Singapore (SG); Yun Luo, Singapore (SG); Santosh Lachhman Achhra, Singapore (SG); Anandan Ethirkottai Sundararajan, Singapore (SG); Haochuan Zhang, Singapore (SG)

(72) Inventors: Xi Li, Singapore (SG); Weilong Liu, Singapore (SG); Mo Yang, Singapore (SG); Yun Luo, Singapore (SG); Santosh Lachhman Achhra, Singapore (SG); Anandan Ethirkottai Sundararajan, Singapore (SG); Haochuan Zhang, Singapore (SG)

(21) Appl. No.: 15/170,669

(22) Filed: Jun. 1, 2016

(51) Int. Cl. G06Q 20/22; G06Q 50/00; H04L 12/58; H04L 29/08

(52) U.S. Cl. CPC G06Q 20/29; H04L 67/1044; G06Q 50/01; H04L 51/04

(57) ABSTRACT

One embodiment of the invention is directed to a method comprising, receiving, by a server computer, a request to establish a group identifier for a group. A group identifier is generated for the group. Group invitations to join the group are transmitted and group invitation responses are received. The method further comprises receiving, by the server computer, confirmations to share a group transaction. A plurality of messages are initiated, the plurality of messages corresponding to the plurality of confirmations, where the plurality of messages result in an initiation of a single message to a third-party, the third-party computer being configured to conduct the group transaction according the single message.

### BACKGROUND

Embodiments of the invention are directed to systems and methods related to conducting a group transaction.

The Internet has made it increasingly easy for consumers to conduct electronic transactions using computing devices such as mobile devices (e.g., mobile phones, tablet computers, etc.). However, transactions conducted over the Internet using mobile applications are usually conducted by a single user and not a group of users.

Current techniques for enabling multiple users (e.g., a group) to share in a group transaction include a single user conducting a single transaction on behalf of one or more other users. Alternatively, each person may manually conduct a separate transaction related to the group resulting in multiple messages being sent to a processing system. These approaches are inconvenient for the user and/or a waste of computing resources and network bandwidth. Although various approaches have attempted to address these drawbacks, these approaches include clear disadvantages. For example, some approaches require users who are sharing a transaction to share a common attribute. Other approaches provided by third-parties may not have the flexibility to optimize the transaction procedure, which can lead to an unfortunate user experience.

Thus, there is a need for new and enhanced methods for enabling a group of users to conduct a group transaction that optimizes computing resources and conserves network bandwidth while providing a positive user experience to the user.

### BRIEF SUMMARY

Embodiments of the invention address these and other problems, individually and collectively.

One embodiment of the invention is directed to a method comprising, receiving, by a server computer, a request to establish a group identifier for a group. The method further comprises generating, by the server computer, the group identifier for the group. The method further comprises transmitting, by the server computer to a plurality of user devices operated by a plurality of users, group invitations to join the group. The method further comprises receiving, by the server computer from at least a subset of the plurality of user devices, group invitation responses. The method further comprises receiving, by the server computer from the at least the subset of the plurality of user devices, confirmations to share a group transaction. The method further comprises initiating a plurality of messages corresponding to the plurality of confirmations, wherein the plurality of messages result in an initiation of a single message to a third-party computer, the third-party computer being configured to conduct the group transaction according to the single message.

Another embodiment of the invention is directed to a server computer comprising a processor and a computer readable medium coupled to the processor, the computer readable medium comprising code, executable by the processor, for implementing a method. The method comprises receiving a request to establish a group identifier for a group. The method further comprises generating the group identifier for the group. The method further comprises transmitting, to a plurality of user devices operated by a plurality of users, group invitations to join the group. The method further comprises receiving, from at least a subset of the plurality of user devices, group invitation responses. The method further comprises receiving, from the at least the subset of the plurality of user devices, confirmations to share a group transaction. The method further comprises initiating a plurality of messages corresponding to the plurality of confirmations, wherein the plurality of messages result in an initiation of a single message to a third-party computer, the third-party computer being configured to conduct the group transaction according to the single message.

These and other embodiments of the invention are described in further detail below.

### BRIEF DESCRIPTION OF THE DRAWINGS

FIG. 1 shows a block diagram of a system according to an embodiment of the invention.

FIG. 2 shows a block diagram of an application server computer architecture according to an embodiment of the invention.

FIG. 3 shows a flow diagram of a method for conducting a group transaction utilizing a single message to a third party according to an embodiment of the invention.

FIG. 4 shows a flow diagram illustrating a method of creating a group according to an embodiment of the invention.

FIG. 5 shows an example interface for creating or joining a group according to an embodiment of the invention.

FIG. 6 shows an example interface for creating a group transaction according to an embodiment of the invention.

FIG. 7 shows an additional example interface for creating a group transaction according to an embodiment of the invention.

FIG. 8 shows a flow diagram illustrating a method of joining a group according to an embodiment of the invention.

FIG. 9 shows an example interface for joining a group according to an embodiment of the invention.

FIG. 10 shows an example interface for providing transaction details according to an embodiment of the invention.

FIG. 11 shows a flow diagram illustrating a method of confirming group transaction information according to an embodiment of the invention.

FIGS. 12-14 show example interfaces for providing group transaction details according to an embodiment of the invention.

### DETAILED DESCRIPTION

Embodiments of the present invention may be directed at utilizing the infrastructure of an application server computer to perform group transactions. Any functions of the application server computer described herein may be instead provided by a sharing application operating on a user computing device. Similarly, any functions and/or features provided by a sharing application described herein may alternatively be provided by an application server computer.

In some embodiments of the present invention, an interface (e.g., provided by an application server computer) may be utilized to create a group. The record corresponding to the group may be stored in the system and associated with, for example, a group identifier. A number of individuals may be identified by the application server computer and these individuals may be sent electronic group invitations to join the group. Such invitations may be sent via email(s), Short Message Service (SMS) text message(s), Multimedia Messaging Service (MMS) text message(s), or any suitable form of electronic communication. Additionally, or alternatively, an interface provided by the application server computer may enable one or more individuals to search for a pre-existing group and request to join the group. Receipt of a request to join the group and/or a group invitation response indicating a desire by an individual to join the group, may cause the application server computer to associate the requestor with the stored group identifier (e.g., a part of a stored record associated with the group). In at least one example, there may be some individuals that decline to join a group, in which case, the application server computer may only receive responses from a subset of the individuals that were invited to join the group. In examples in which only a subset of the invited individuals respond, group membership may be determined after, for example, a threshold period of time after receipt of a last group invitation response. As a non-limiting example, if five group invitations were sent, and four group invitation responses received, the group membership may be determined to be the four individuals for which responses were received, the determination occurring, for example, 30 seconds after the receipt of the fourth group invitation response. In general, the application server computer may be responsible for maintaining group membership status.

In at least one embodiment, an interface may be provided by the application server computer to enable a user to create a group transaction. The group transaction may include any suitable group transaction data that enables the group transaction to be conducted on behalf of multiple group members. As a non-limiting example, multiple individuals may desire to join a charitable 5K race. In order to register as a group for the race, each person of the group must submit registration information including, but not limited to his or her name, address, and phone number. Accordingly, the application server computer may provide an interface via a sharing application operating on each user's device. The interface may be utilized to enable each user to enter his or her registration information. Upon receiving registration information from each group member, the application server computer may forward the registration information to a processing network computer. The processing network computer, on receipt of the registration information may (or may not) perform one or more validation operations before forwarding the registration information along as a single group transaction. The single group transaction may be utilized to enable each member of the group to be registered as a group, alleviating the need for separate transactions to be utilized for each group member.

Embodiments of the present invention may be used in transaction processing systems or may use data generated during transaction processing through a transaction processing system. Such embodiments may involve transactions between consumers and merchants.

Before discussing detailed embodiments of the invention, some descriptions of certain terms may be useful.

A “computing device” may be any suitable device that can perform computations, and that can communicate with other devices. A mobile device is an example of a computing device. Other types of computing devices may not be mobile.

A “mobile device” may comprise any suitable device can be easily carried by a user. In some embodiments, it may be an electronic device that may be transported and operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of mobile devices include mobile phones (e.g., cellular phones), PDAs, tablet computers, net books, laptop computers, personal music players, hand-held specialized readers, wearable devices (e.g., watches), vehicles (e.g., cars), etc. A mobile device may comprise any suitable hardware and software for performing such functions, and may also include multiple devices or components (e.g., when a device has remote access to a network by tethering to another device—i.e., using the other device as a relay—both devices taken together may be considered a single mobile device).

“Registration information” may include data associated with a user enabling the user to register with a service provider. For example, registration information may include any suitable combination of a name, a shipping address, a phone number, an email address, one or more user preferences, a payment method, a billing address, or any suitable information enabling the service provider to provide a service to the user.

A “group identifier” may include a string of characters, a number, an alphanumeric identifier, or any suitable mechanism for identifying a group (e.g., two or more) of individual people.

A “group invitation” may include one or more electronic communications for eliciting one or more responses from a user with respect to a group. In at least one example, an application server computer may provide an invitation to join a group to a user device of an individual. In some examples, the invitation may include a group identifier associated with the group pertaining to the invitation.

A “group invitation response” may include one or more communications for providing feedback from a user with respect to a group. In at least one example, an application server computer may receive a group invitation response indicating that the invited individual wishes to join a particular group. In some examples, the group invitation response may include additional data such as a payment amount, a share, a portion, a percentage, or any suitable data indicating a sub-portion of a group transaction for which the individual claims ownership.

“Group transaction information” may include any suitable information that enables a group transaction to be conducted. For example, group transaction information may include, but is not limited to, a transaction identifier, a merchant account identifier, an amount, a name, an address, a phone number, payment information, a height, a weight, a body type and/or build, or any suitable information needed to conduct a group transaction.

A “confirmation message” may be an electronic message that confirms an event. In some embodiments, it may be an electronic message that is sent from a user device, and that confirms group membership of an individual operating the user device. In some examples, the confirmation message may include data such as a payment amount, a share, a portion, a percentage, or any suitable data indicating a sub-portion of a group transaction for which the individual claims ownership.

A “transaction request message” may be an electronic message that includes information related to a group transaction. As a non-limiting example, in a group purchase transaction (e.g., splitting of a restaurant bill), the transaction request message may include a total bill amount, a subtotal, a taxes amount, a merchant identifier, or the like.

A “payment account attribute inquiry message” may be an electronic message that enables an inquiry corresponding to a particular account. In at least one example, the account may be managed by a financial institution. In at least one example, the payment account attribute inquiry message may include an account number (e.g., a primary account number (PAN)).

A “payment account attribute inquiry response message” may be an electronic message that provides account information corresponding to a particular account. In at least one example, the account information pertains to an account managed by a financial institution. In at least one example, the payment account attribute inquiry response message may include a product identification code, a product name, a product sub-type code, a product sub-type name, a card type code, a card sub-type code, a product platform code, issuer information (e.g., an issuer name and/or country code), a billing currency code, a decimal position indicator, a fast funds indicator, a push payment indicator, an online gambling block indicator, or any suitable combination of the above. In at least one example, the fast funds indicator indicates whether or not the issuer of a recipient account is enabled to make transferred funds available within 30 minutes of authorizing a transfer.

A “push funds transaction” may be an electronic message that adheres to an application programming interface for providing functionality to push funds to a recipient account (e.g., an account operated by a financial institution). In at least one examples, an Original Credit Transaction (OCT) can operate using an application interface for providing the functionality of a push funds transaction. A push funds transaction may include information such as recipient information, transaction amount, sender information, transaction identifier, etc.

A “multi-push funds transaction” may be an electronic message that adheres to an application programming interface for providing functionality to push funds to multiple recipient accounts (e.g., each account operated by a common or different financial institution). In at least one embodiment, the multi-push funds transaction may include information pertaining to multiple push funds transactions.

A “pull funds transaction” may be an electronic message that adheres to an application programming interface for providing functionality to pull funds from a sender's account (e.g., an account operated by a financial institution). In at least one examples, an Account Funding Transaction (AFT) may operate using an application interface for providing the functionality of a pull funds transaction. A pull funds transaction may include information such as sender information, transaction amount and fees (if applicable), point of sale information, etc.

A “multi-pull funds transaction” may be an electronic message that adheres to an application programming interface for providing functionality to pull funds from multiple senders' accounts (e.g., each account operated by a common or different financial institution). In at least one embodiment, the multi-push funds transaction may include information pertaining to multiple pull funds transactions.

A “processing network computer” may be one or more computers that provide one or more operations for processing a transaction. As a non-limiting example, a processing network computer may provide one or more application programming interfaces (e.g., APIs for providing push funds transactions, pull funds transactions, multi-push funds transactions, multi-pull funds transactions, and the like).

A “sharing application” may be a software application that is provided by an application server computer for a specific purpose. In at least some examples, a sharing application may be a software application that is provided to perform a variety of group transactions. Group transactions may relate to, for example, eCommerce, social networks, money transfer/personal payments, mobile commerce, proximity payments, gaming, and/or the like for retail purchases, digital goods purchases, utility payments, purchasing games or gaming credits from gaming websites, transferring funds between users, although this is not an exhaustive list.

An “authorization request message” may be an electronic message that is used to authorize a payment for a financial transaction. In some examples, an authorization request message is sent to a payment processing network and/or an authorizing computer to request authorization for a transaction. An authorization request message according to some embodiments may comply with ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current group transaction, such as the transaction amount assigned to the individual, a merchant identifier, a merchant location, etc., as well as any other information that may be utilized in determining whether to identify and/or authorize a transaction.

An “authorization response message” may be an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

A “merchant” may typically be an entity that engages in transactions and can sell goods or services, or provide access to goods or services.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

An “authorizing entity” may be an entity that authorizes a request. Examples of an authorizing entity may be an issuer, a governmental agency, a document repository, an access administrator, etc.

An “issuer” may typically refer to a business entity (e.g., a bank) that maintains an account for a user. An issuer may also issue payment credentials stored on a user device, such as a cellular telephone, smart card, tablet, or laptop to the consumer.

“User account information” may include data associated with a user. As a non-limiting example, user account information may include a user name, a user password, an address, a phone number, an email address, a shipping address, a billing address, a number of user preferences, payment information, or the like.

A “server computer” is typically a powerful computer or cluster of computers. For example, the server computer can be a large mainframe, a minicomputer cluster, or a group of servers functioning as a unit. In one example, the server computer may be a database server coupled to a Web server.

A “processor” may refer to any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

### I. Systems

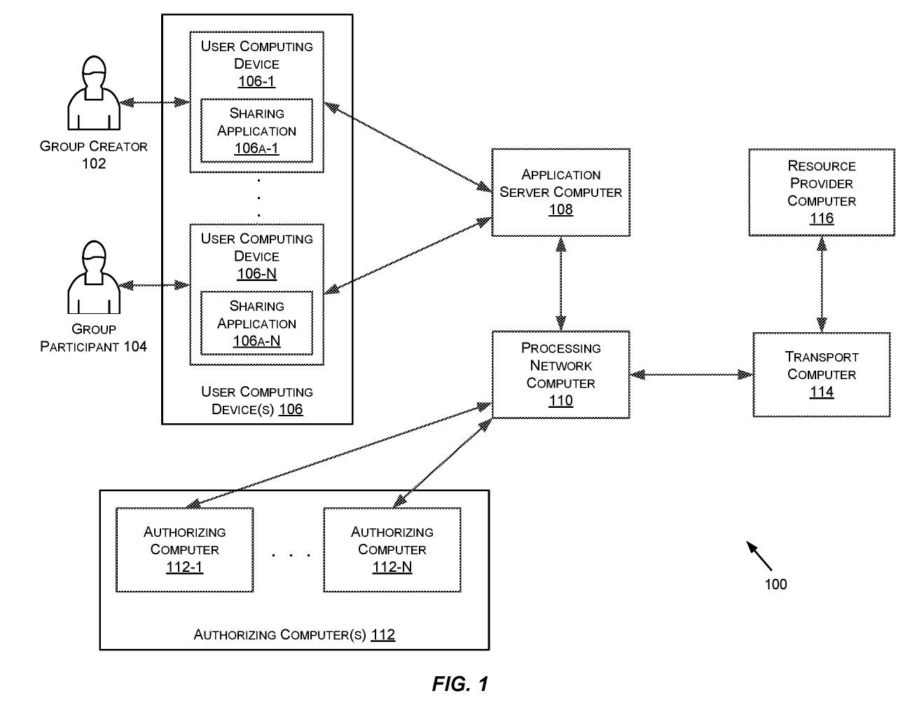

FIG. 1 shows a block diagram of a system 100 according to an embodiment of the invention. The system 100 may comprises a group creator 102, a group participant 104, user computing devices 106, an application server computer 108, a processing network computer 110, authorizing computers 112, a transport computer 114, and a resource provider computer 116. Each of these systems and computers may be in operative communication with each other. For simplicity of illustration, a certain number of components are shown in FIG. 1. It is understood, however, that embodiments of the invention may include more than one of each component. In addition, some embodiments of the invention may include fewer than or greater than all of the components shown in FIG. 1. In addition, the components in FIG. 1 may communicate via any suitable communication medium (including the Internet), using any suitable communications protocol.

The user computing device(s) 106 may have any suitable characteristics. The user computing device(s) 106 may individually include a processor and a computer readable medium coupled to the processor, the computer readable medium comprising code, executable by the processor for performing the functionality described herein. The user computing device(s) 106 may be communicatively coupled to the application server computer 108 via a communications medium in order to conduct a group transaction with a resource provider (e.g., a merchant) associated with the resource provider computer 116. In some embodiments, the user computing device(s) 106 may be in communications with a resource provider computer 116 through the application server computer 108, the processing network computer 110, and the transport computer 114.

The user computing device(s) 106 may be in any suitable form. Example of user computing device(s) 106 includes any device capable of accessing the Internet, such as a personal computer, cellular or wireless phones, personal digital assistants (PDAs), tablet computers, laptop computers, and handheld specialized readers. The user computing device(s) 106 may transmit data through the communications medium to the application server computer 108.

In at least one embodiment, user computing device(s) 106 may be operated by individual users (e.g., a group creator 102, a group participant 104, or the like). In at least one embodiment, one or more interfaces may be provided by the application server computer 108 to a user of a user computing device via a sharing application operating on the user computing device. A user may interact with the application server computer 108 utilizing the sharing application in order to receive and transmit information related to a group and/or a group transaction.

The application server computer 108 may be one or more computers provided by a service provider. In some embodiments, application server computer 108 may manage and provide services to a user via a user computer device. The services may be provided to the user via a sharing application stored a user's computer device. The application server computer 108 may send over-the-air (OTA) messages to the sharing application. In at least one example, the application server computer 108 may be responsible for providing one or more network pages associated with the processing network. The application server computer 108 may be accessed via a website accessible to the user computing device(s) 106 and operated by the processing network computer 110. This website may be configured to be accessible from an application (e.g., a browser application, the sharing application, etc.) operating on the user computing device(s) 106. The sharing application may be configured to receive and transmit group information and/or group transaction information using one or more service calls. For example, the application server computer 108 may be configured to handle service call requests from the sharing application. The application server computer 108 may serve, in response to received requests, various user interfaces that may be rendered at the user computing device(s) 106.

As a non-limiting example, the application server computer 108 may provide one or more interfaces (directly, or via the sharing applications 106A-1 to 106A-N) to a group creator 102. In a non-limiting example, the group creator 102 may utilize such interfaces to input various information (e.g., a name, a location, etc.) to define a group. In some cases, the group creator 102 may utilize the provided interfaces to input one or more identifiers (e.g., a phone number, an email address, or the like) that individually identify a potential group member. Group defining information and/or group identifiers may be communicated to the application server computer 108 by the sharing application operating on a corresponding user device.

In at least one embodiment, one or more interfaces may be provided by the application server computer 108 (directly, or via the sharing applications 106A-1 to 106A-N) to a user (e.g., the group creator 102, and/or the group participant 104) to view/create a group transaction. As a non-limiting example, the group creator 102 may utilize the one or more interfaces to input group transaction information. Such information may be communicated to the application server computer 108 (e.g., by the sharing application operating on a corresponding user device).

In at least one embodiment, one or more interfaces may be provided by the application server computer 108 (directly, or via the sharing applications 106A-1 to 106A-N) to the group participant 104 (e.g., via a sharing application 106A-N operating on the user computing device 106-N). In a non-limiting example, the one or more interfaces may be utilized by the group participant 104 to input various identifying information (e.g., a name, a location, etc.) for a group. In some examples, the group participant 104 may utilize the one or more interfaces to search for a group (e.g., by group identifier, by location, or the like). The group participant 104 may utilize an interface provided by the application server computer 108 to indicate a desire to join an identified group. Such information may be communicated to the application server computer 108 (e.g., in a group invitation response) via the sharing application 106A-N.

In at least one embodiment, one or more interfaces may be provided by the application server computer 108 (directly, or via the sharing applications 106A-1 to 106A-N) to one or more users (e.g., the group creator 102 and/or the group participant 104) to provide information related to a group and/or a group transaction. For example, such interfaces may be utilized to communicate a transaction amount associated with a user (e.g., the group participant 104). A same or additional interface may be utilized to enable to the user to confirm and/or edit transaction information (e.g., the transaction amount). Confirmed and/or edited transaction information may be communicated to the application server computer 108 via, for example, a sharing application operating on the corresponding user computing device.

The application server computer 108 may be configured to maintain group membership information associated with a number of groups. For example, the application server computer 108 can receive a group identifier for a group. On receipt of a group identifier, or at another suitable time, the application server computer 108 may create and store a record that is associated with a particular group. The record, in some examples, may be used by the application server computer 108 to maintain information related to group membership such as indicators and/or identifier of members of the group. The record may further store a group identifier associated with a particular group. In some examples, the application server computer 108 may utilize the group identifier as a lookup for the record.

In at least one embodiment, the application server computer 108 may be configured to maintain group transaction information for a number of group transactions. Group transaction information may be associated with a particular group transaction. For example, the application server computer 108 can store a record for each group transaction or a record for more than one group transaction. The record, in some examples, may maintain group transaction information such as, but not limited to, a transaction amount, one or more shares of the transaction amount. The record may further store a group identifier for a particular group associated with the group transaction. In some cases, group membership information and group transaction information may be stored in a common record maintained by the application server computer 108.

In at least one embodiment, the application server computer 108 may be configured to provide a number of interfaces discussed above with respect to the user computing device(s) 106 via a corresponding sharing application operating on a user computer device. For example, the application server computer 108 may provide one or more interfaces via the sharing application to enable a user to create a group, join a group, search for a group, create a group transaction, confirm/edit transaction information related to a group transaction, or the like.

The processing network computer 110 may be configured to provide authorization services, and clearing and settlement services for payment transactions. A processing network computer 110 may include data processing subsystems, networks, and operations used to support and deliver authorization services, exception file services, and clearing and settlement services. An exemplary processing network computer may be included in a processing network such as VisaNet™. The processing network computer 110 may expose one or more application programming interfaces associated with a service such as VisaDirect™. In at least one example, the service may provide push and pull fund capabilities by providing one or more APIs, such as an API for pushing funds, an API for pulling funds, an API for pushing funds to multiple accounts, and an API for pulling funds from multiple accounts. In at least some examples, processing network computers are able to process credit card transactions, debit card transactions, and other types of commercial transactions. Processing network computers operating in VisaNet™, in particular, may include a Visa Integrated Payments (VIP) system which processes authorization requests and a Base II system which performs clearing and settlement services. Furthermore, the processing network computer 110 may include a server computer and may use any suitable wired or wireless telecommunications network, including the Internet. In some embodiments, the processing network computer 110 may forward an authorization request received from the transport computer 114 to the authorizing computer(s) 112 via a communication channel. The processing network computer 110 may further forward an authorization response message received from the authorizing computer(s) 112 to the transport computer 114.

The authorizing computer(s) 112 may individually be operated by a corresponding account issuer. Typically an issuer is an entity (e.g., a bank) that issues and maintains an account of a user (e.g., the group participant 104). The account may be a credit, debit, prepaid, or any other type of account. The authorizing computer(s) 112 may each be a stand-alone entity or may be coupled to, integrated into, and/or operated or managed by any of the entities shown in FIG. 1.

The transport computer 114 may be operated by an acquirer. An acquirer is typically a system for an entity (e.g., a bank) that has a business relationship with a particular resource provider (e.g., a merchant) or another entity. The transport computer 114 may be communicatively coupled to the resource provider computer 116 and the processing network computer 110 and may issue and manage an account of the resource provider. In some embodiments, the transport computer 114 may forward an authorization request message to the processing network computer 110 and an authorization response message to the resource provider computer 116 during a transaction to confirm processing of a payment transaction.

The resource provider computer 116 may be associated with any suitable resource provider. In some examples, the resource provider may be a merchant. The resource provider computer 116 may be, for example, an access device such as a POS terminal at a location, a computer coupled with an access device of a merchant, or a remote server computer that operates a web site operated by the merchant. In some embodiments, the merchant operating the resource provider computer 116 may be a card-on-file (COF) merchant. The card-on-file merchant may store consumer account information in a remote database for future payments (e.g., recurring or periodic payments). The resource provider computer 116 may be configured to generate an authorization request message for a transaction. In some embodiments, the resource provider computer 116 may generate multiple authorization request messages if the transaction involves multiple authorizations.

The resource provider computer 116 may include any suitable computational apparatus operated by a resource provider (e.g., a merchant). The resource provider computer 116 may include a processor and a computer readable medium coupled to the processor, the computer readable medium comprising code, executable by the processor for performing the functionality described herein. Examples of resource provider computer 116 may include an access device or a point of sale device. In some embodiments, the resource provider computer 116 may include a web server computer that may host one or more websites associated with the merchant. In some embodiments, the resource provider computer 116 may be configured to send and receive data to/from the transport computer 114 as part of a transaction procedure (e.g., payment verification and authentication process) between the user (e.g., consumer) and the resource provider (e.g., the merchant).

Messages between the computers, networks, and devices in FIG. 1 may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

Each of the entities in FIG. 1 may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

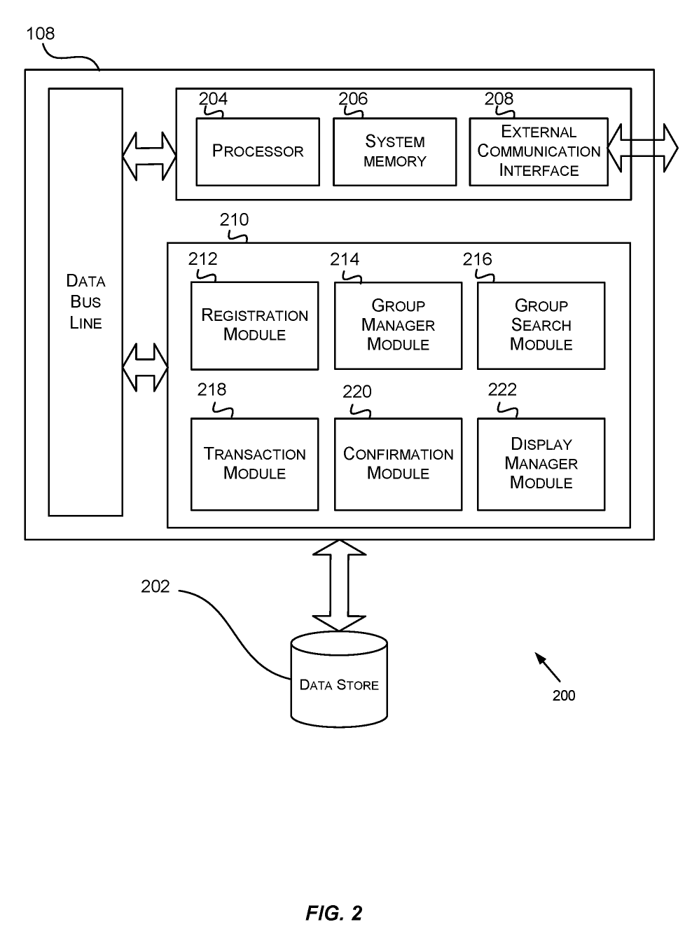

FIG. 2 shows a block diagram 200 of an application server computer architecture (e.g., for the application server computer 108 of FIG. 1) according to an embodiment of the invention. FIG. 2 shows the application server computer 108 communicatively couple to a data store 202. The data store 202 may be configured as depicted in FIG. 2, or the data store 202 may be provided, in whole or in part, as part of the application server computer 108. The data store 202 may be utilized to store one or more records containing user account information, group information, and/or group transaction information processed by the application server computer 108. It should be appreciated that the functionality of the modules depicted in FIG. 2 may be alternatively provided as part of a sharing application associated with the application server computer 108 (the sharing application of FIG. 1).

The data store 202 (as well as any other database described herein) may be a conventional, fault tolerant, relational, scalable, secure database such as Oracle™ or Sybase™. The data store 202 may be implemented using various standard data-structures, such as an array, hash, (linked) list, structured text file (e.g., XML), table, and/or the like. Such data-structures may be stored in memory and/or in (structured) files.

The application server computer 108 may comprise a processor 204, which may be coupled to a system memory 206 and an external communication interface 208. A computer readable medium 210 may also be operatively coupled to the processor 204.

The computer readable medium 210 may comprise a number of software modules including a registration module 212, a group manager module 214, a group search module 216, a transaction module 218, a confirmation module 220, and a display manager module 222.

The registration module 212 may comprise code that, when executed, causes the processor 204 to transmit, receive, and/or store user account information. For example, the registration module 212 may receive user account information from a user. Such user account information may be collected by an interface provided by a component of the computer readable medium 210 (e.g., display manager module 222). In at least one example, the registration module 212 may transmit user account information to the data store 202 for storage as part of a user account associated with the user. In other examples, the registration module 212 may store user account information as part of a user account associated with the user.

The group manager module 214 may comprise code that, when executed, causes the processor 204 to transmit, receive, and/or store group information. For example, the group manager module 214 may receive a request to establish a group identifier. Such a request may be initiated by an interface provided by a component of the computer readable medium 210 (e.g., display manager module 222). The group manager module 214, upon receipt of such a request, may generate a group identifier for a group. In some example, the received request may include a group identifier to be used for a group. The group manager module 214 may cause the processor to execute instructions to store the group identifier (e.g., in the data store 202, or another suitable storage location) as part of a record associated with the group. In at least one embodiment, the group manager module 214 may cause the processor to transmit group invitations to join a group to one or more users. Such invitations may be included in any suitable electronic communication, including, but not limited to, an interface provided by a component of the computer readable medium 210 (e.g., display manager module 222).

In at least one embodiment, the group manager module 214 may cause the processor receive group invitation responses in response to the group invitations transmitted. Upon receipt of a group invitation response, the group manager module 214 may cause the processor to execute instructions to store data associated with the group invitation response identifier (e.g., in the data store 202, or another suitable storage location) as part of a record associated with the group. In at least one example, the group manager module 214 may cause both the group identifier and group invitation response information to be stored in a single record associated with the group. In at least one embodiment group manager module 214 may interact with the display manager module 222 to provide group information to a user (e.g., via a sharing application operating on a computing device of the user).

The group search module 216 may comprise code that, when executed causes the processor 204 to receive search parameters corresponding to a group search. In at least one example, such search parameters may include a location, one or more characters, one or more numbers, one or more symbols, or any suitable combination of the above. The group search module 216 may comprise additional code that causes the processor 204 to execute a search query (e.g., including one or more received search parameters) on the data store 202 or another suitable storage location that includes one or more group records. The group search module 216 may receive search results corresponding to the query and may include instructions that, when executed, causes a component of the computer readable medium 210 (e.g., the display manager module 222) to cause the processor 204 to provide such search results to a user (e.g., rendered via the sharing applications operating on the user computing device(s) 106 of FIG. 1).

The transaction module 218 may comprise code that, when executed, causes the processor 204 to transmit, receive, and/or store group transaction information. For example, the transaction module 218 may receive a request to create and/or modify a group transaction. Such a request may be initiated by an interface provided by a component of the computer readable medium 210 (e.g., display manager module 222). The transaction module 218, upon receipt of such a request, may generate a group transaction for a group. In some examples, the received request may include a group identifier to identify a group associated with the group transaction. The transaction module 218 may cause the processor to execute instructions to store the group transaction information (e.g., in the data store 202, or another suitable storage location) as part of a record associated with the group. In at least one embodiment, the transaction module 218 may comprise code that, when executed, causes the processor 204 to store the group transaction information in a common record with respect to the group identifier and/or group invitation response information. In at least one embodiment the transaction module 218 may interact with the display manager module 222 to provide group transaction information to a user (e.g., via a sharing application operating on a computing device of the user).

The confirmation module 220 may comprise code that, when executed, causes the processor 204 to transmit, receive, and/or store one or more confirmations to share a group transaction. For example, the confirmation module 220 may receive a confirmation initiated by a particular user that indicates that the user desires to take part in the group transaction. A confirmation, in this context, can be initiated by an interface provided by a component of the computer readable medium 210 (e.g., display manager module 222). In at least some examples, the confirmation may include a portion of an overall transaction amount. In at least one embodiment, the confirmation module 220 may comprise code that, when executed, causes the processor 204 to allocate a share of the group transaction to individual users of a group. In at least one embodiment the confirmation module 220 may interact with the display manager module 222 to provide information related to a confirmation and/or a transaction share to a user (e.g., via a sharing application operating on a computing device of the user).

In at least one embodiment, the confirmation module 220 may comprise code that, when executed, causes the processor 204 to determine whether or not a confirmation has been received for every member of a group. If confirmations have been received for each group member, the confirmation module 220 may comprise further code for providing a group transaction a utilizing a multi-push transaction and/or a multi-pull transaction. As a non-limiting example, the confirmation module 220 may comprise code that, when executed, causes the processor 204 to initiate (or cause initiation of) a single message (e.g., a multi-push transaction or a multi-pull transaction), the single message including transaction information corresponding to each confirmation into a single message to a third party (e.g., the processing network computer 110). The confirmation module 220 may further comprise code that transmits the single message to a third-party computer (e.g., the processing network computer 110).

The display manager module 222 may comprise code, which causes the processor 204 to provide one or more interfaces to a user. In at least one embodiment, the one or more interfaces may be provided via an application (e.g., a sharing application such as the sharing application 106A-1 of FIG. 1, a browsing application, etc.) operating a user computing device or may alternatively be provided via a website hosted by the application server computer 108.

The computer readable medium 210 may comprise code, executable by the processor to implement a method comprising: receiving, by a server computer, a request to establish a group identifier for a group; generating, by the server computer, the group identifier for the group; transmitting, by the server computer, to a plurality of user devices operated by a plurality of users, group invitations to join the group; receiving, by the server computer from a subset of the plurality of user devices, group invitation responses; receiving, by the server computer from the subset of the plurality of user devices, confirmations to share a group transaction; and initiating a plurality of messages corresponding to the plurality of confirmations, wherein the plurality of messages result in an initiation of a single message to a third-party computer, the third-party computer being configured to conduct the group transaction according to the single message.

### II. Methods

A. Conducting a Group Transaction

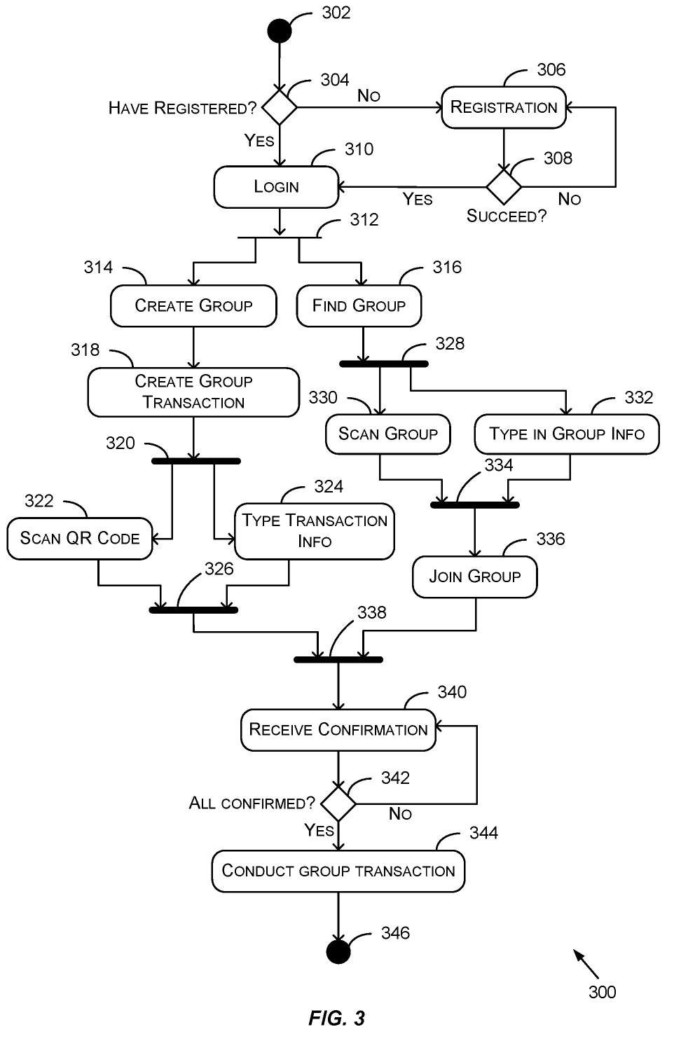

FIG. 3 shows a flow diagram of a method 300 for conducting a group transaction, according to an embodiment of the invention. Additional methods and processes may be included within these methods and may be recognized by one of ordinary skill in the art, in light of the description below. Further, in some embodiments of the present invention, the described methods may be combined, mixed, and matched, as one of ordinary skill would recognize. Although the methods that are specifically described below can relate to payment processing, embodiments of the invention can be applied to other areas that do not require payment.

At step 302, a user may provide login information pertaining to a user account utilizing an interface provided by the application server computer 108 of FIG. 1. In some embodiments, the user may enter such login information into a website hosted by the application server computer 108 by using a browser application or the user may access a sharing application (e.g., the sharing application 106A-1 or the sharing application 106A-N of FIG. 1) stored on a user computing device (e.g., the user computing device(s) 106 of FIG. 1) to provide login information.

At step 304, a determination may be made by the application server computer 108 as to whether or not the user has previously registered with the login information. If the user has not previously registered with the application server computer 108 of FIG. 1, the flow may proceed to step 306, where the user may utilize an interface provided by the application server computer 108 to input registration information. At step 308, a determination is made as to whether or not registration succeeded. If registration was unsuccessful, the flow may return to step 306 to enable the user to reenter registration information utilizing the provided interface. If, however, the registration was successful, the flow proceeds to step 310, where the user is logged in to the system. Alternatively, the determination at step 304 may indicate that the user has previously registered with the system. In this case, the flow may proceed directly to step 310, where the user is logged into the system.

At step 312, the application server computer 108 may provide the user with two options. For example, a component of the application server computer 108 (e.g., the display manager module 222 of FIG. 2) may cause the processor 204 of FIG. 2 to provide (e.g., via a sharing application operating on the user's computing device) a “create group” option at step 314 and/or a “find group” option at 316.

Upon selecting the “create group” option at step 314, a component of the application server computer 108 (e.g., the display manager module 222) provides the user an interface to enable the user to provide group information (e.g., a group identifier) for the group. Upon receipt of the group information, a component of the application server computer 108 (e.g., the group manager module 214) may create record for the group and associate the record with the group information.

The flow may proceed to step 318, where a component of the application server computer 108 (e.g., the display manager module 222) provides a “create group transaction” option. Upon selecting the option to create a group transaction at step 318, the user is provided two options at step 320 (e.g., by the display manager module 222). At step 322, the user selects an option to scan a quick response (QR) code. Upon selecting the option, the user may utilize the user computing device to scan a QR code associated with a transaction (e.g., a restaurant bill). Alternatively, the user can select an option to type in group transaction information at step 324. Upon selecting the option at step 324, the user may utilize an interface provided by the application server computer 108 to manually provide group transaction information. Upon successful submission of group transaction information at step 322 or at step 324, a group transaction will be created at step 326 (e.g., by the transaction module 218 of FIG. 2.

The user may alternatively find a group for which a group transaction already exists by selecting the “find group” option at step 316. Upon selecting the option to find a group, the application server computer 108 may provide a number of options at step 328. The options may include, but are not limited to, a “scan group” option and/or a “type in group information” option. At step 330, the application server computer 108 may provide an interface to scan for a group. Upon selecting such an option, a component of the application server computer 108 (e.g., the group search module 216 of FIG. 2) may provide the user with a list of nearby groups (e.g., groups that were created by a user of a device that is geographically within a threshold distance of the user's computing device). Alternatively, the application server computer 108 may provide the user with an interface to type in group information upon selection of the option at step 332. Regardless of the option selected at step 330 or at step 332, the user may select a group to join at step 334. At step 336, a component of the application server computer 108 (e.g., the group manager module 214) may add the user's information to a group record causing the user to join the group.

At step 338, a component of the application server computer 108 (e.g., the display manager module 222) provides to the user information regarding the group transaction associated with the group created/joined. The application server computer 108 further enables the user to confirm group transaction information at step 338. For example, the user may confirm an amount associated with a group transaction, the amount being a sub-portion (e.g., $10) of a total amount associated with the group transaction (e.g., $50). At step 340, a component of the application server computer 108 (e.g., the confirmation module 220) receives a confirmation indicating that the user confirms the accompanying group transaction information.

At step 342, a component of the application server computer 108 (e.g., the confirmation module 220) makes a determination as to whether or not each group member has confirmed the group transaction information. If there are still group members for which confirmation have not been received, then the application server computer 108 may wait for receipt of the next confirmation at step 340 to reassess the situation. Alternatively, the component of the application server computer 108 (e.g., the confirmation module 220) may make a determination at step 342 that all group members have confirmed the group transaction information. Accordingly, a component of the application server computer 108 (e.g., the confirmation module 220) may cause the processor 204 of FIG. 2 to perform operations at step 344 comprising conducting the group transaction according to the group transaction information. In at least one example, conducting a group transaction may include initiating a single message, such as a multi-push transaction and/or a multi-pull transaction, to include group information and transmitting the single message to a third-party computer (e.g., the processing network computer 110 of FIG. 1). Upon completion of the group transaction, the flow may conclude at step 346.

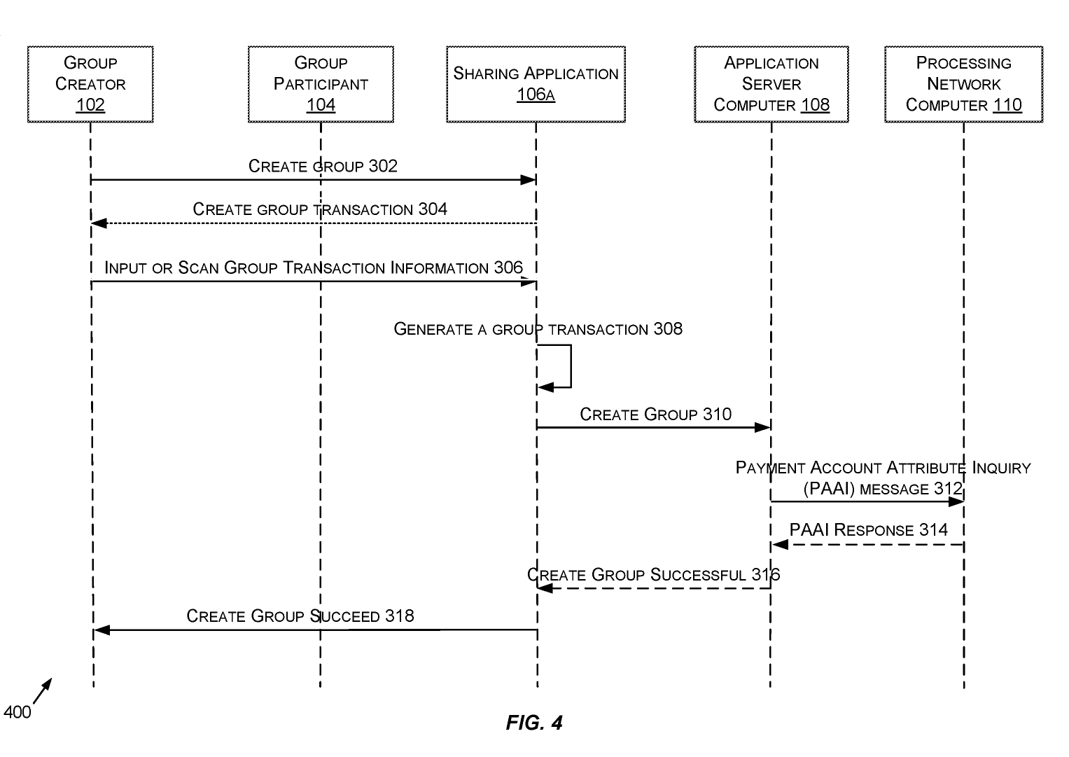

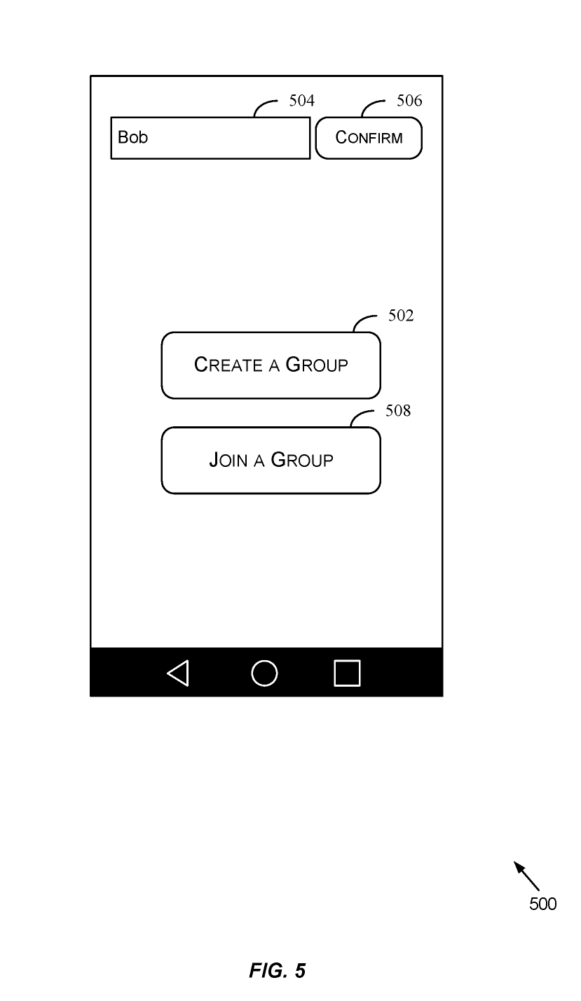

FIG. 4 shows a flow diagram 400 illustrating a method of creating a group according to an embodiment of the invention. For example, the method may begin at 302, where a group creator (e.g., the group creator 102 of FIG. 1) may select an option to create a group utilizing an interface provided by the application server computer 108 via a sharing application 106A (e.g., the sharing application 106A-1 of FIG. 1). FIG. 5 shows an example interface 500 for creating or joining a group according to an embodiment of the invention.

In at least one embodiment, the interface 500 may include an option 502 to create a group. Upon selection of the option 502, the user may be provided an edit box 504, for example, in order to enable the user to enter a group name. The user may utilize graphical element 506 to confirm the group name or otherwise indicate that their input has concluded. Upon selection of the graphical element 506, the sharing application 106A of FIG. 4 may provide the user with an interface to create a group transaction at 304.

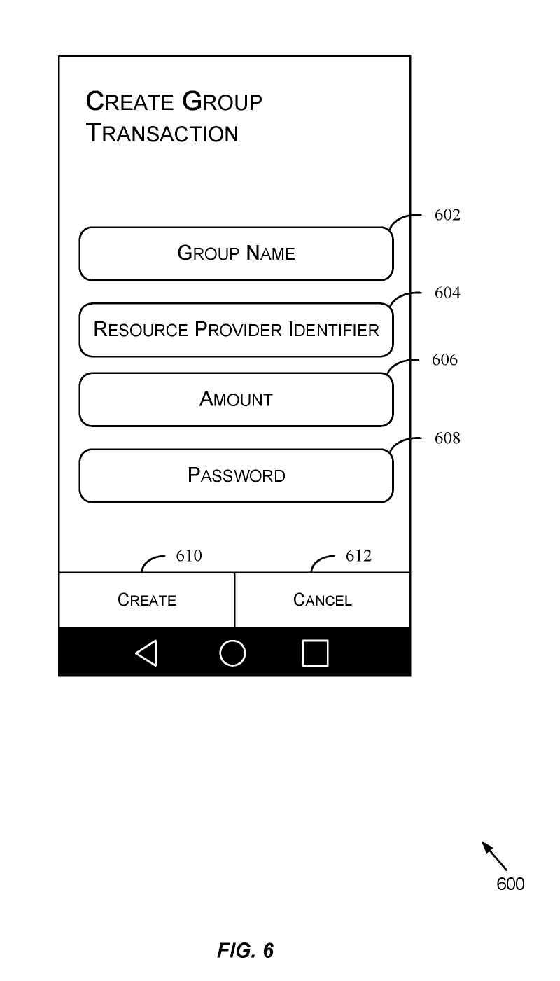

One such interface for creating a group transaction is depicted in FIG. 6. The example interface 600 includes edit box 602, edit box 604, edit box 606, edit box 608, graphical element 610, and graphical element 612. It should be appreciated that any combination of the elements of the example interface 600 may be utilized as an interface for creating a group transaction. In the example interface depicted in FIG. 6, a user may utilize the edit box 602 to enter a group identifier (e.g., a group name). The user may further utilize the edit box 604 to provide a resource provider identifier (e.g., a merchant account number). The edit box 606 may be utilized to provide an amount (e.g., a bill amount associated with a restaurant bill, a taxi bill amount, etc.) associated with the group transaction. The edit box 608 of the example interface 600 may be utilized to provide a password with which to protect the group transaction information. If a password is provided utilizing the edit box 608, the group transaction information may remain private unless a group member is able to provide a correct password to the application server computer 108 (e.g., the transaction module 218 of FIG. 2). Upon entering information in one of the aforementioned edit boxes, the user may select the graphical element 610 to indicate that he wishes to create a group transaction with the inputted information of edit boxes 602-608. Alternatively, the user may select the graphical element 612 to indicate that he wishes to abort creation of a group transaction.

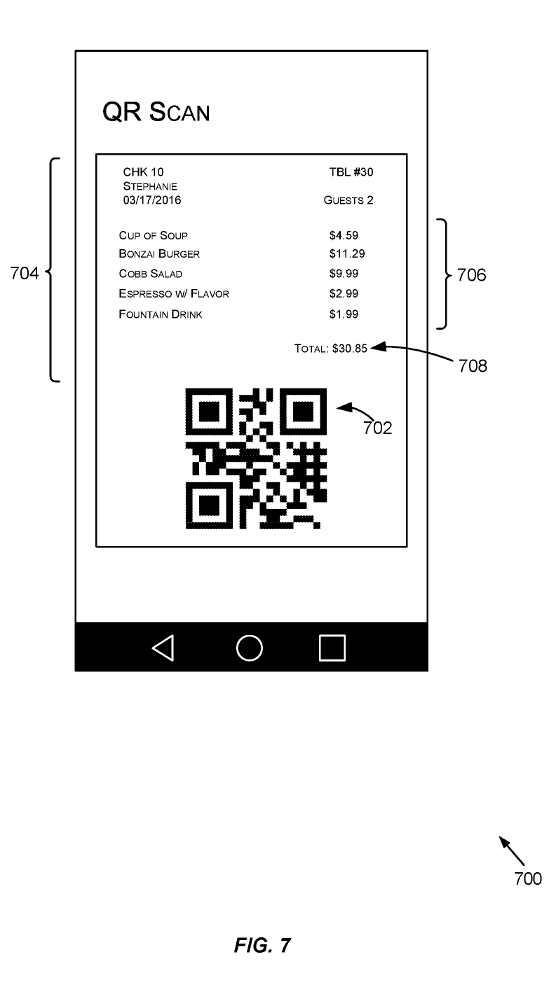

FIG. 7 shows an additional example interface 700 for creating a group transaction according to an embodiment of the invention. Upon selecting an option to scan a QR code (e.g., a QR code having impeded group transaction information) the user may utilize his user computing device to scan the QR code 702. “Scanning” the QR code may include utilizing a camera and/or viewfinder of the user computing device. In at least one embodiment, the QR code 702 may include embedded group transaction information. For example, the QR code 702 may include group transaction information corresponding to a restaurant bill depicted at 704. The group transaction information, in this example, includes a bill identifier (e.g., CHK 10), an employee identifier (e.g., “Stephanie”), a table identifier (e.g., TBL #30), a number of guests (e.g., 2), a date of service (e.g., Mar. 17, 2016), a number of itemized amounts at 706, and a total transaction amount at 708. It should be appreciated that the QR code 702 may include any suitable combination of the group transaction information depicted in FIG. 7 and/or any suitable combination of group transaction information not depicted in FIG. 7.

Returning to the flow diagram 400 of FIG. 4, upon inputting or scanning group transaction information, such information may be collected by the sharing application 106A. Upon receipt of such information, the sharing application may generate a group transaction at 308 corresponding to the received group transaction information. At 310, the sharing application 106A may communicate the group information and the group transaction information to the application server computer 108. Receipt of such information may cause the application server computer to create and store the information in a record associated with a group identifier (e.g., the group identifier provided via the edit box 504 of FIG. 5).

Upon successful creation of the group, a component of the application server computer 108 (e.g., the transaction module 218 of FIG. 2) may cause the processor 204 of FIG. 2 to transmit a payment account attribute inquiry message to the processing network computer 110 at 312 in order to verify that the resource provider account (e.g., a bank account of the merchant associated with the group transaction) supports the push/pull/multi-push/multi-pull funds transaction APIs. At 314, the application server computer 108 receives a PAAI response indicating what APIs are supported by the resource provider account. If the PAAI response indicates that the resource provider account does, in fact, support the push/pull/multi-push/multi-pull APIs, a message indicating that creation of the group was successful is communicated to the sharing application 106A at 316. Accordingly, the sharing application 106A may provide an indicate to the group creator 102 that the group was successfully created at 318.

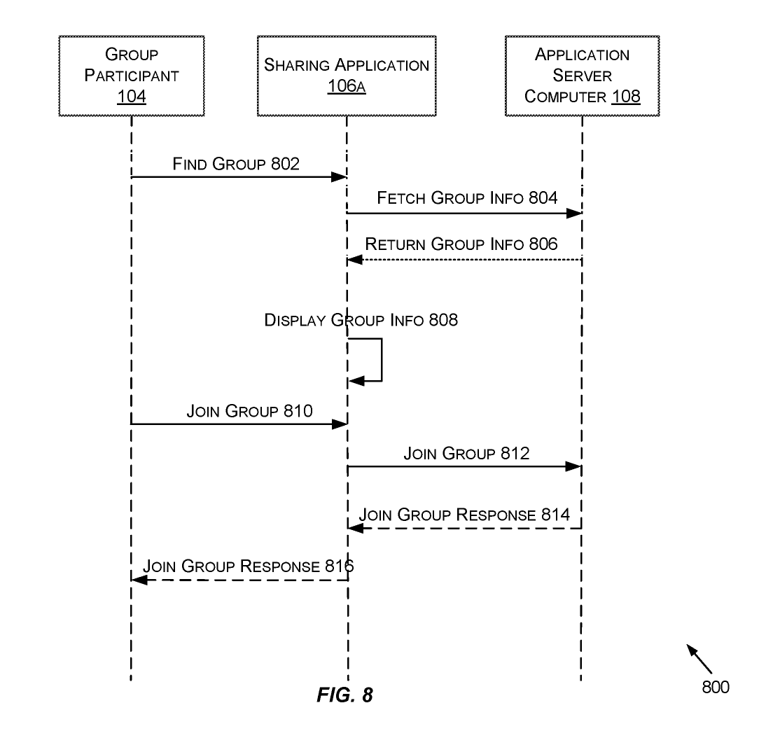

FIG. 8 shows a flow diagram illustrating a method 800 of joining a group according to an embodiment of the invention. The method may begin at 802 where the group participant 104 of FIG. 1 may interact with the sharing application 106A-N to find a group. In some embodiments, the user may select an option such as option 508 of FIG. 5. Upon selection of the option 508, the user may be provided an edit box, or other suitable graphical element, with which to enter a group identifier (e.g., a group name). In at least one embodiment, the sharing application 106A-N may utilize the user-entered group identifier to fetch group information from the application server computer 108 at 804. A component of the application server computer 108 (e.g., the group search module 216 of FIG. 2) may execute a query utilizing, for example, the user-entered group identifier in order to retrieve group information. At 806, the application server computer 108 may return the group information to the sharing application 106A-N. At 808, the sharing application 106A-N(as instructed by a component of the application server computer 108 such as the display manager module 222 of FIG. 2) may display the group information to the group participant 104.

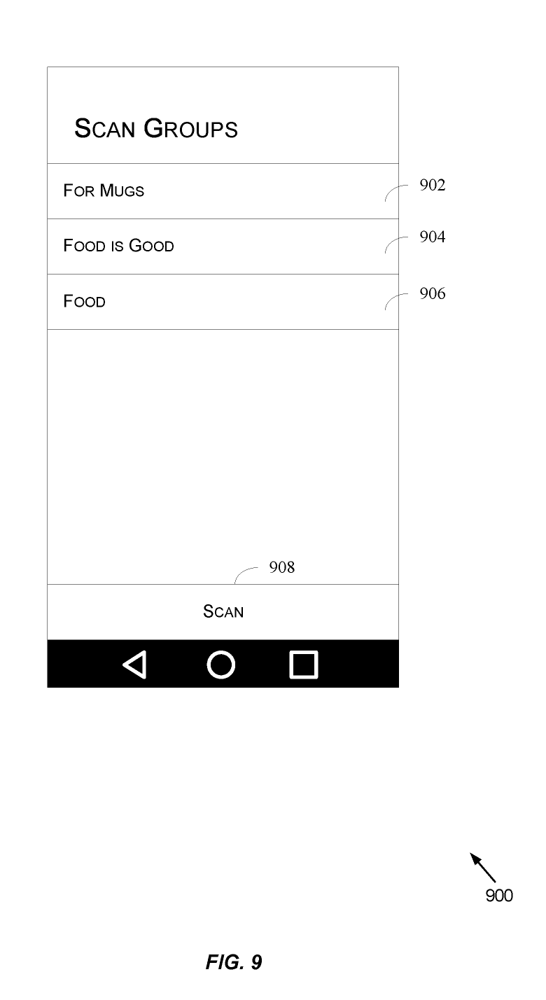

Alternatively, the user may select an option to scan for a group. Upon selecting such an option, the sharing application 106A-N (as instructed by a component of the application server computer 108 such as the display manager module 222 of FIG. 2) may provide the user an interface such as the one depicted in FIG. 9 for providing group information pertaining to nearby groups. In the example depicted in FIG. 9, three group identifiers are provided (e.g., “For Mugs,” “Food is Good,” and “Food”). The sharing application 106A-N fetch group information at 804 from the application server computer 108, the group information corresponding to one or more nearby groups. For example, the application server computer 108 may execute a query to find groups that were created within a threshold geographic distance of the user computer device operated by the group participant 104. The application server computer 108 (e.g., via the group search module 216) may provide the search results to the sharing application 106A-N (e.g., via the display manager module 222). The sharing application 106A-N may display, or otherwise render, group information corresponding to one or more groups that were found nearby. For example, the sharing application 106A-N (as instructed by a the display manager module 222) may provide selectable graphical elements 902-906 that correspond to three groups that were found to have been created within a threshold geographical distance (e.g., 50 feet) from the user computing device operated by the group participant 104. The graphical elements 902-906 may be utilized by the group participant 104 in order to select a particular group to join. In at least one embodiment, the sharing application 106A-N may provide a graphical element 908 to enable the group participant 104 to initiate a new scan for nearby groups.

In at least one embodiment, the user may utilize the group information displayed at 808 to select a particular group to join at 810. Such a selection may be communicated to the application server computer 108 via the sharing application 106A-N at 812. Upon receipt of the selection, the application server computer 108 may execute instructions that cause the group participant 104 to be associated with the selected group. At 814, the application server computer 108 may provide to the sharing application 106A-N, a response indicating whether or not the group participant 104 was successfully associated with the group. The sharing application 106A-N (as instructed by a the display manager module 222) may display such information to the group participant 104 at 816.

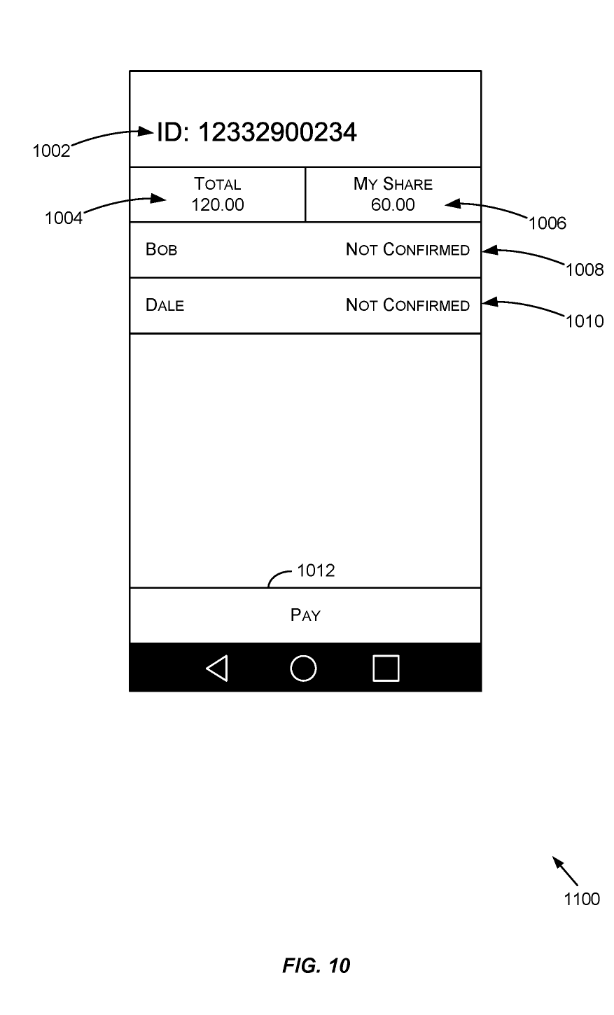

For example, FIG. 10 shows an example interface 1000 for providing transaction details (e.g., utilizing the display manager module 222 of FIG. 2) according to an embodiment of the invention. The sharing application 106A-N may use the interface 1000 to display to the user group transaction information such as, for example, a group identifier 1002, a total amount 1004, a share of the total amount 1006 that is allocated to the group participant 104, a confirmation status 1008 for the group participant 104, and a confirmation status 1010 of another group member. In at least one example, the share of the total amount 1006 that is allocated to the group participant 104 is defaulted to a proportional share of the total amount 1006. In the example depicted in FIG. 10, the group participant 104 (e.g., “Bob”) is allocated half of the bill, while the other half is allocated to another group member (e.g., “Dale”). In at least one embodiment, the sharing application 106A-N (or the application server computer 108) may provide the user the ability to edit the share of the total amount 1006 that is allocated to the group participant 104. The group participant 104 may confirm his share by selecting the graphical element 1012 (e.g., a “Pay” button). In at least one example, the sharing application 106A-N (of the application server computer 108) may collect confirmations from each member in the group before continuing to process the group transaction.

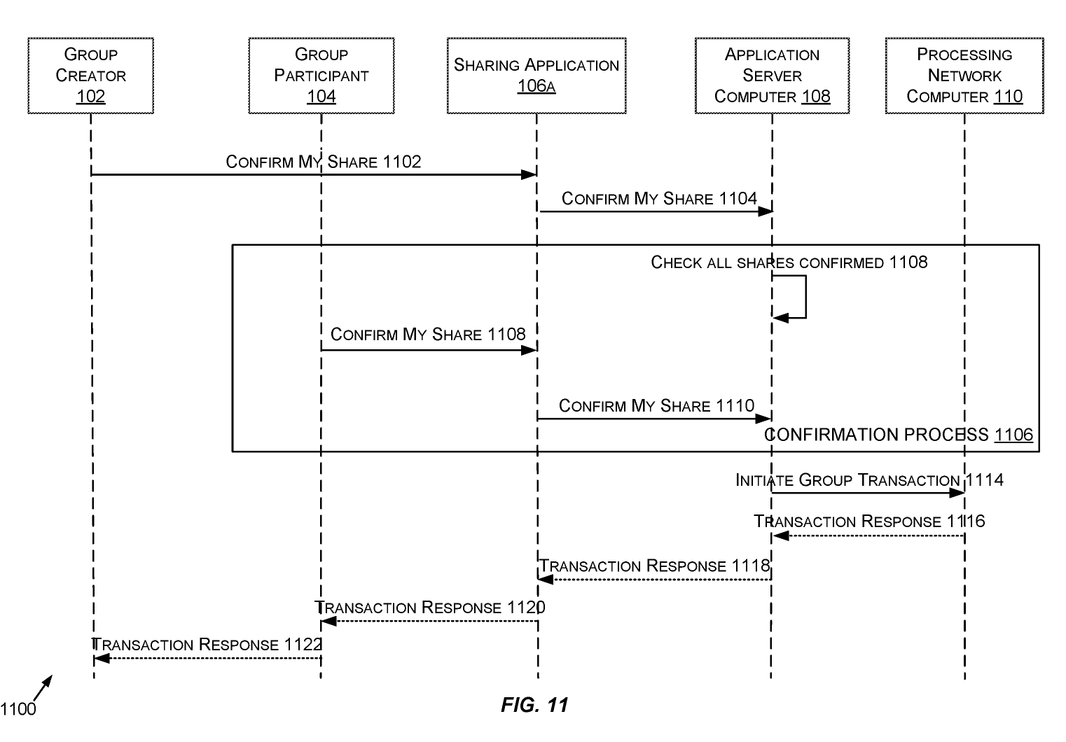

FIG. 11 shows a flow diagram illustrating a method 1100 of conducting a group transaction according to an embodiment of the invention. For illustrative purposes, the group creator 102 is assumed to also be a group participant of a group associated with a group transaction. Accordingly, the group creator 102 may confirm his share of the group transaction at 1102. As described above, the interface 1000 may be utilized by the group creator 102 to provide such a confirmation. The sharing application 106A (e.g., the sharing application 106A-1) may receive the confirmation(s) to share a group transaction and may forward the confirmation(s) to the application server computer 108 to perform a confirmation process 1112. As part of the confirmation process 1112, the application server computer 108 may determine whether or not a confirmation message has been received for each member of the group at 1108. If confirmation messages have not been received for each member of the group, the application server computer 108 may refrain from initiating any further transaction.

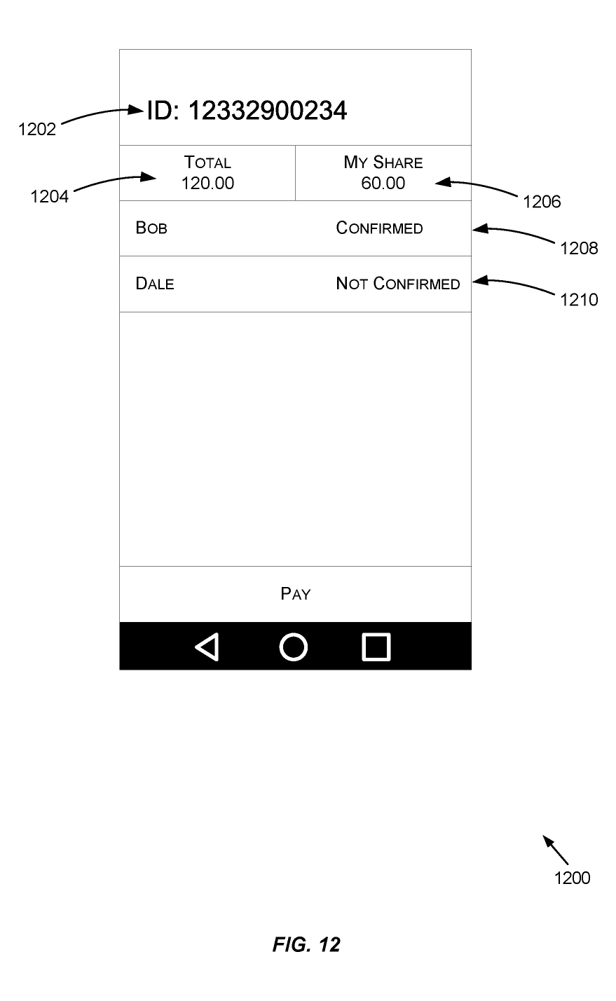

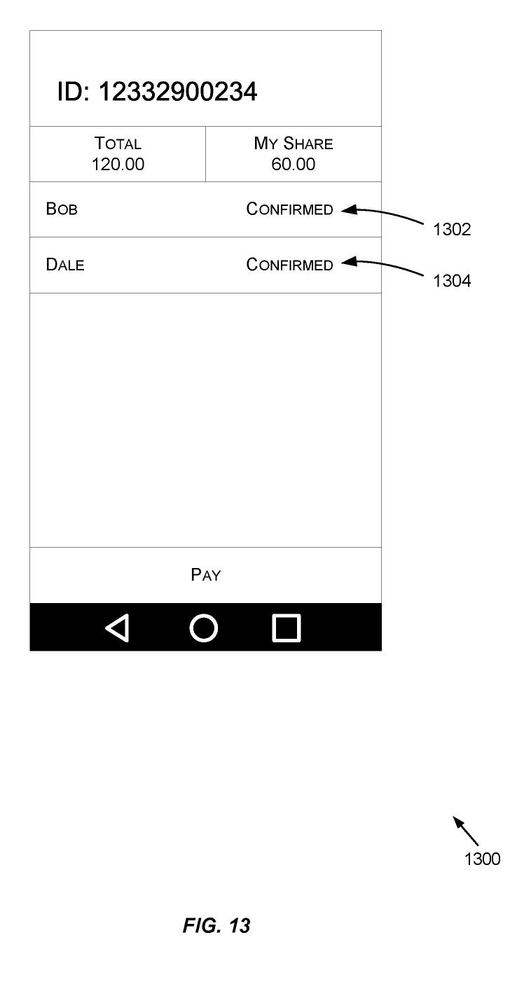

In at least one embodiment, a group participant 104 may interact with the sharing application 106A (e.g., the sharing application 106A-N) in order to confirm his share at 1108 (e.g., utilizing an interface provided by the display manager module 222 such as the one depicted in FIG. 10). Upon receiving the confirmation from the group participant 104, the sharing application 106A may forward the confirmation to the application server computer 108 at 1010. The application server computer 108 may return to 1108 to determine whether or not a confirmation message has been received for each member of the group. If confirmation messages are still not received for each member in the group, the confirmation process 1106 may be repeated until confirmations have been received for each group member. In at least one example, upon receiving the confirmation from the group participant 104 (or the group creator 102) the sharing application 106A or the application server computer 108 may provide feedback to the user. FIG. 12 is provided to illustrate an example interface 1200 for providing such feedback. In the example depicted in FIG. 12, a group identifier 1202, a total amount 1204, a share of the total amount 1206 that is allocated to the group participant 104, a confirmation status 1208 for the group participant 104, and a confirmation status 1210 of another group member is provided. In the example depicted in FIG. 12, the group participant 104 has confirmed his share of $60.00 as indicated by the confirmation status 1208 (“Confirmed”) while the other group member has not confirmed his share as indicated by the confirmation status 1010 (“Not Confirmed”). When a confirmation has been received (by the sharing application 106A of FIG. 11 and/or the application server computer 108 of FIG. 11) for the other group member (“Dale”), the interface of FIG. 12 may be updated as depicted in FIG. 13. In FIG. 13, the interface 1300 shows that both group member have confirmed their shares as indicated by confirmation status 1302 and confirmation status 1304.

Returning to FIG. 11, upon concluded the confirmation process 1106, a component of the application server computer 108 (e.g., the confirmation module 220) may initiate a group transaction 1114 (e.g., directly, or via the transaction module 218). Initiation of the group transaction may include initiating (or causing the initiation of) a single message (e.g., a multi-push funds transaction, or a multi-pull funds transaction) that includes information corresponding to the plurality of confirmations and transmitting the single message to the processing network computer 110. Receipt of the single message (e.g., a multi-pull funds transaction) from the application server computer 108 may cause the processing network computer 110 to submit one or more authorization request messages (e.g., an AFT message) to one or more authorizing computers (e.g., the authorizing computer(s) 112 of FIG. 1). Each of the authorizing computer(s) 112 may provide an authorization response message to the processing network computer 110. Upon receiving an authorization response message corresponding to each group member, the processing network computer 110 may submit a single OCT message to a transport computer (e.g., the transport computer 114 of FIG. 1). Receipt of such a message by the transport computer 114 may cause the transport computer 114 to credit an account associated with a resources provider an amount corresponding to an amount indicated in the OCT message.

In some embodiments, the authorization request messages are AFT messages and the transaction messages are AFT transactions. An AFT (Account Funding Transaction) is a transaction designed to supply funds to another account such as a Visa prepaid, debit, ATM card or on-line account. The AFT eventually will result in a debit to the sender's payment (card) account. Assuming that funds are available from the sender (or that credit is available), the issuer approves the transaction and the operator of the portal receives an indication via a processing network computer such as VisaNet that the authorization is successful.

As noted above, the crediting of the resource provider's account may be performed using an OCT transaction. Use of the OCT transaction generally assumes that the service provider bank and the recipient's issuer bank are different banks, and in that situation, the OCT transaction provides a convenient mechanism for money transfer. If the service provider bank and the recipient's issuer bank are the same bank, it is possible for that bank to simply perform an internal “on-us” credit posting to credit funds to the recipient's payment (card) account. Nevertheless, it is entirely possible that when the service provider bank and the recipient's issuer bank are the same bank, that the bank will choose to execute an OCT transaction rather than use their internal systems. This situation can occur if it is more difficult for the bank to connect internal systems than it is to execute an OCT transaction. In some cases, the time lag from the submission of the OCT transaction by the service provider bank to the actual credit of the recipient's card account can be two days or less.

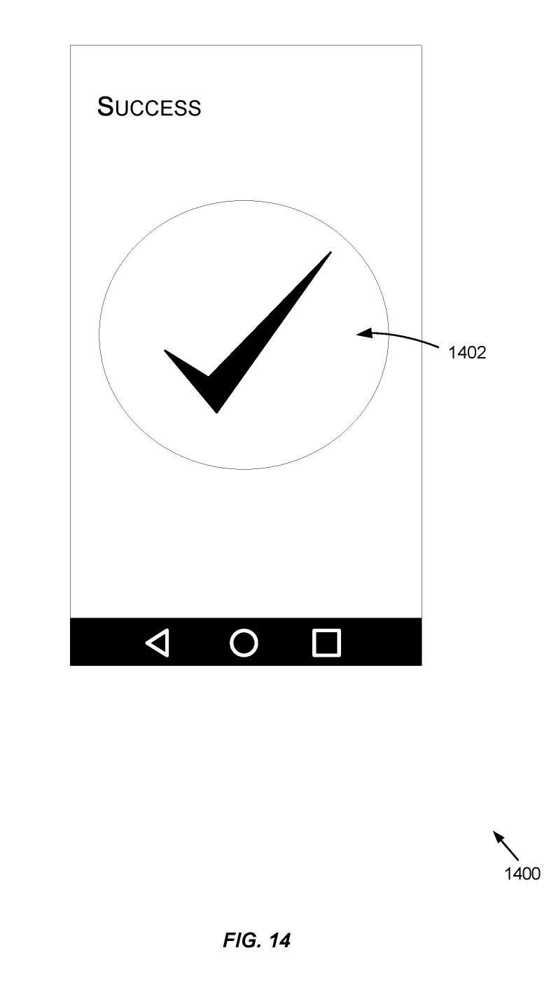

Upon successful transmission of the OCT message, or at another suitable time, the processing network computer 110 may provide a transaction response at 1116. Upon receipt of the transaction response, the application server computer 108 may forward the transaction response to the sharing application 106A at 1118. Accordingly, the sharing application 106A may provide information from the transaction response to the group participant 104 at 1120 and/or to the group creator 102 at 1122. An example interface 1400 is provided in FIG. 14 that depicts information stemming from receipt of the transaction response. For example, the sharing application 106A may provide the user with a status indication 1402 to indicate that the group transaction was successful. The interface 1400 is merely illustrative in nature, any suitable form of status feedback may be utilized.

At a later point in time, a clearing and settlement process may optionally occur between the authorizing entities (e.g., issuers) associated with the group members and the authorizing entity (e.g., an issuer) or acquirer associated with the resource provider (e.g., a merchant).

### III. Technical Benefits

Embodiments of the present invention may also provide for faster transaction processing as it reduces the friction that occurs in transactions where users are required to perform multiple transactions individually instead of as a group. By including multiple transactions of a group into a single group transaction, computing resources and network bandwidth are conserved. Sharing electronic transactions is a problem that is routed in technology. By providing the embodiments of the invention described above, a solution is provided to enable a group of users to share a transaction in an user-friendly, efficient manner.

Also, as noted above, in embodiments of the invention, multiple debit messages may be sent to the various group members' issuers and this may be initiate the transmission of a single credit message to the resource provider's financial institution. If, for example, there are five customers at a restaurant, a single credit message may be sent to the resource providers' financial institution rather than five separate credit messages. This reduces the number of messages that would be transmitted relative to conventional group payment methods, and reduces the chances for errors, thereby improving transaction efficient.

### IV. Example Computer Systems

The various participants and elements described herein may operate one or more computer apparatuses to facilitate the functions described herein. Any of the elements in the above-described FIG. 1, including any servers or databases, may use any suitable number of subsystems to facilitate the functions described herein.

Examples of such subsystems or components shown in the above figures may be interconnected via a system bus. Additional subsystems such as a printer, keyboard, fixed disk (or other memory comprising computer readable media), monitor, which is coupled to display adapter, and others may be included. Peripherals and input/output (I/O) devices, which couple to I/O controller (which can be a processor or other suitable controller), can be connected to the computer system by any number of means known in the art, such as a serial port. For example, the serial port or an external interface can be used to connect the computer apparatus to a wide area network such as the Internet, a mouse input device, or a scanner. The interconnection via system bus allows the central processor to communicate with each subsystem and to control the execution of instructions from system memory or a fixed disk, as well as the exchange of information between subsystems. The system memory and/or the fixed disk may embody a computer readable medium.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method, comprising:
receiving, by a server computer, a request to establish a group identifier for a group;
generating, by the server computer, the group identifier for the group;
transmitting, by the server computer to a plurality of user devices operated by a plurality of users, group invitations to join the group;
receiving, by the server computer from at least a subset of the plurality of user devices, group invitation responses;
receiving, by the server computer from the at least the subset of the plurality of user devices, confirmations to share a group transaction; and
initiating a plurality of messages corresponding to the plurality of confirmations, wherein the plurality of messages result in an initiation of a single message to a third-party computer, the third-party computer being configured to conduct the group transaction according to the single message.

2. The method of claim 1, further comprising:
receiving a transaction request message to create the group transaction; and
in response to receiving the transaction request message, generating the group transaction for the group.

3. The method of claim 1, further comprising:
allocating a share of the group transaction to individual users of the plurality of user devices according to the plurality of confirmations; and
providing, to the plurality of user devices, an indication of the share of the group transaction that is allocated to the individual users.

4. The method of claim 3, wherein receiving the confirmations to share the group transaction are received in response to providing, to the plurality of user devices, the indication of the share of the group transaction allocated to the individual users.

5. The method of claim 1, wherein an individual transaction of the plurality of transactions corresponds to an allocated share of the group transaction that is allocated to a particular user of the plurality of users.

6. The method of claim 1, wherein the group transaction is associated with a payment.

7. The method of claim 6, wherein the allocated share comprises a portion of the payment.

8. The method of claim 1, wherein the group invitations to join the group utilize the group identifier.

9. The method of claim 1, wherein the group invitation responses are received in response to the invitations to join the group.

10. The method of claim 1, further comprising providing, to the subset of the plurality of user devices, a transaction result associated with the single message.

11. A server computer, comprising:
a processor, and
a computer readable medium coupled to the processor, the computer readable medium comprising code, executable by the processor, for implementing a method comprising:
receiving a request to establish a group identifier for a group;
generating the group identifier for the group;
transmitting, to a plurality of user devices operated by a plurality of users, group invitations to join the group;
receiving, from at least a subset of the plurality of user devices, group invitation responses;
receiving, by the server computer from the at least the subset of the plurality of user devices, confirmations to share a group transaction; and
initiating a plurality of messages corresponding to the plurality of confirmations, wherein the plurality of messages result in an initiation of a single message to a third-party computer, the third-party computer being configured to conduct the group transaction according to the single message.

12. The server computer of claim 11, the method further comprising:
receiving a transaction request message to create the group transaction; and
in response to receiving the transaction request message, generating the group transaction for the group.

13. The server computer of claim 11, the method further comprising:
allocating a share of the group transaction to individual users of the plurality of user devices according to the plurality of confirmations; and
providing, to the plurality of user devices, an indication of the share of the group transaction that is allocated to the individual users.

14. The server computer of claim 13, wherein receiving the confirmations to share the group transaction are received in response to providing, to the plurality of user devices, the indication of the share of the group transaction allocated to the individual users.

15. The server computer of claim 11, wherein an individual transaction of the plurality of transactions corresponds to an allocated share of the group transaction that is allocated to a particular user of the plurality of users.

16. The server computer of claim 11, wherein the group transaction is associated with a payment.

17. The server computer of claim 16, wherein the allocated share comprises a portion of the payment.

18. The server computer of claim 11, wherein the group invitations to join the group utilize the group identifier.

19. The server computer of claim 11, wherein the group invitation responses are received in response to the invitations to join the group.

20. The server computer of claim 11, the method further comprising providing, to the subset of the plurality of user devices, a transaction result associated with the single message.
